(19) United States
(12) Patent Application Publication
(10) Pub. No.: US 2013/0031817 A1
(43) Pub. Date: Feb. 7, 2013

(54) Magnetic menu planner

(71) Applicants: Amy Beth Case, Bowie, MD (US); Denise Marie Lucas, Bowie, MD (US)

(72) Inventors: Amy Beth Case, Bowie, MD (US); Denise Marie Lucas, Bowie, MD (US)

(73) Assignee: Amy Beth Case, Bowie, MD (US)

(21) Appl. No.: 13/561,084

(22) Filed: Jul. 30, 2012

Related U.S. Application Data
(60) Provisional application No. 61/574,395, filed on Aug. 3, 2011.

(51) Int. Cl. G09F 3/08

(52) U.S. Cl. 40/661.01

(57) ABSTRACT

An improved system for menu planning that consists of a magnetic mat printed with a calendar and customizable, blank magnetic tabs. The magnetic mat affixes to a refrigerator and the magnetic tabs are labeled and placed next to the mat to make menu planning as easy as selecting a magnetic tab and placing it on the mat. Additional household needs can be planned with the blank magnetic tabs.

### CROSS REFERENCE TO RELATED APPLICATIONS

This invention uses the transmission of the provisional application, 61/574,395, Filed 2011 Aug. 3.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

This invention relates to methods of menu planning in a household. Many solutions have been created in an attempt to make the process of planning a menu easier to accomplish so that the benefits of menu planning can be gained. The most common solution is to use a paper template which shows the days of the week and upon which the menu is written. Other solutions include using a white board or computer software program to plan a menu, or a service which provides already written menus on a regular basis. There are several disadvantages with the previous solutions offered. With the use of paper templates or a white board, it can be difficult to remember the variety of dishes that one can implement in the menu. Additionally, white boards can be difficult to keep clean and paper templates are wasteful of natural resources if they are not recycled. Computer programs can remember a variety of dishes, but they are not as readily accessible in the kitchen where menu planning is utilized. Services that provide weekly menus may include foods that are not desirable or unaffordable.

The present invention has significant advantages over the prior art. The magnetic sheet affixes directly to the refrigerator or other magnet attractant surface and allows a person to repeatedly use the calendar template printed upon the surface. The addition of customizable blank magnetic tabs allows for a person to personalize the tabs with their own menu items. These are also kept on the refrigerator or hanging next to the planner. This allows the meal ideas to remain visible which aids in the process of meal planning The planning process is as easy as selecting a magnetic tab and placing the tab onto the magnetic planner on the desired day. The magnetic component makes this system very flexible and easy to use. Also, because the magnetic tabs are customizable, a person can track chores, medications, appointments or any other item which would be deemed beneficial to them.

### BRIEF SUMMARY OF THE INVENTION

The invention herein comprises of a magnetic mat and blank magnetic tabs, both of which are customizable, that affix to a refrigerator or are otherwise hung on a magnet attractant surface in a vertical fashion so that menu planning or any other household planning desired is easily performed.

### BRIEF DESCRIPTION OF THE SEVERAL VIEWS OF DRAWINGS

The following is a description, by way of example, of a preferred embodiment of the present invention, reference being had to the accompanying drawings in which:

FIG. 1 is a front view of the invention known as the magnetic mat with blank magnetic tabs attached.

FIG. 2 is a top view of the magnetic mat with blank magnetic tabs attached.

FIG. 3 is a front view of the blank magnetic tabs.

FIG. 4 is a top view of the blank magnetic tabs.

While the invention will be described in conjunction with the illustrated embodiment, it will be understood that it is not intended to limit the invention to such embodiment. On the contrary, it is intended to cover all alternative, modifications and equivalents as may be included within the spirit and scope of the invention as defined by the appended claims.

### DETAILED DESCRIPTION OF THE INVENTION

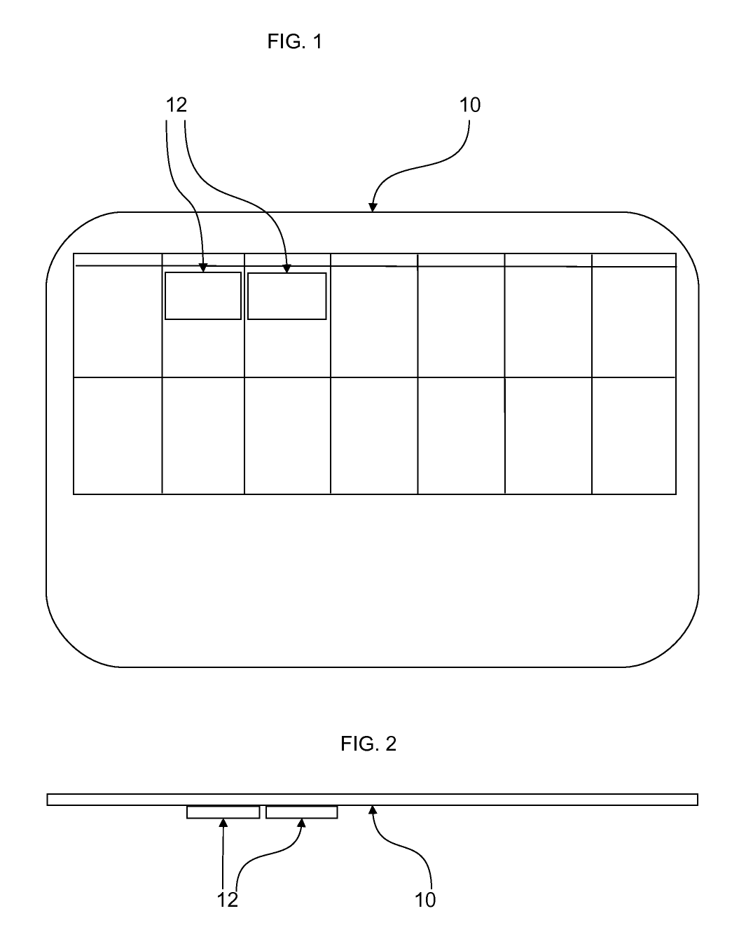

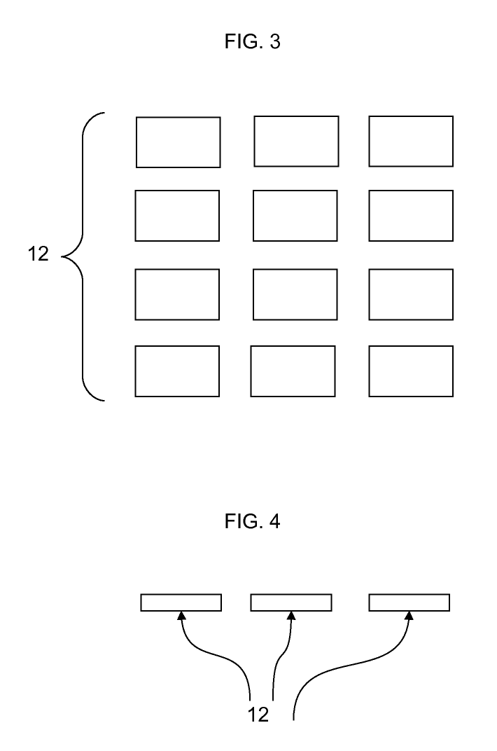

Referring to FIG. 1, this invention comprises a magnetic mat 10 and blank magnetic tabs 12. The magnetic mat is attached to the refrigerator or other magnet attractant surface, in a vertical fashion. The mat is printed with a calendar format showing any number of weeks available for planning The mat can also be personalized or made decorative by printing the mat with pictures and colors.

The blank magnet tabs are not limited in number. The blank magnetic tabs are labeled by a person, either by hand or with a label maker, with the meals of their choosing and placed next to the magnetic mat on the refrigerator or other magnetic attractant surface. Meal planning is performed by selecting the magnetic tabs and placing them on the calendar printed on the mat on the desired day of the week.

This is a system to allow a person to easily menu plan or track other household needs.

The embodiments of the invention in which an exclusive property or privilege is claimed are defined as follows:

1. A meal planning system comprising a magnetic mat and a plurality of blank magnetic tabs, both of which are customizable, with said magnetic mat being available in a variety of colors, designs, and sizes, and said magnetic tabs being available in a plurality of colors, sizes, and shapes, which adhere to a magnetic attractant surface or refrigerator.

2. The meal planning system of claim 1, wherein said blank magnetic tabs are be customized with meal ideas for retention of available options in convenient location for ease of meal planning.

3. The meal planning system of claim 1, wherein said magnetic mat and said blank magnetic tabs can be customized for use to track additional household needs including but not limited to chores, medications, appointments, freezer inventory, and dietary requirements.
